(19) United States
(12) Patent Application Publication
(10) Pub. No.: US 2011/0227453 A1
(43) Pub. Date: Sep. 22, 2011

(54) VIBRATION WAVE DRIVING APPARATUS AND METHOD OF MAKING VIBRATING BODY THEREOF

(75) Inventors: Yasuyuki Araki, Kawasaki-shi (JP); Hiroyuki Seki, Oyama-shi (JP)

(73) Assignee: CANON KABUSHIKI KAISHA, Tokyo (JP)

(21) Appl. No.: 13/047,673

(22) Filed: Mar. 14, 2011

(30) Foreign Application Priority Data
Mar. 16, 2010 (JP) 2010-058779
Jan. 18, 2011 (JP) 2011-007695

(51) Int. Cl. H02N 2/12; H02K 15/00

(52) U.S. Cl. 310/323.02; 29/596

(57) ABSTRACT

An apparatus includes a vibrator, the vibrator including a vibrating body on which a protrusion having a spring characteristic is formed and an electromechanical energy conversion element, wherein the vibrator performs an elliptical motion so as to drive an object that is in contact with the protrusion, and wherein the protrusion is integrally formed with the vibrating body from one member in a partial area of the vibrating body with respect to a longitudinal direction and a width direction via a plurality of slits or cutouts.

### BACKGROUND OF THE INVENTION

1. Field of the Invention

The present invention relates to a vibration wave driving apparatus and a method of making a vibrating body thereof.

2. Description of the Related Art

Examples of existing linear ultrasonic motors for linearly driving an object include a vibration wave driving apparatus (linear ultrasonic motor) described in U.S. Pat. No. 7,109,639. Referring to FIGS. 10A, 10B-1, and 10B-2, the driving mechanism of the linear ultrasonic motor will be described. FIG. 10A is an external perspective view of a linear ultrasonic motor 510. The linear ultrasonic motor 510 includes a vibrator 501, a slider 506, and a pressing member (not shown) for pressing the vibrator 501 against the slider 506. The vibrator 501 includes an electromechanical energy conversion element 505, which is typically a piezoelectric element, and a vibrating body that is bonded to one side of the electromechanical energy conversion element 505 so as to be integrated with the electromechanical energy conversion element 505. The vibrating body includes a base portion 502, which is rectangular, and two protrusions 503 and 504, which protrude from the upper surface of the base portion 502.

In an ultrasonic motor, a voltage having a specific frequency is applied to a piezoelectric element so as to excite a plurality of desired vibration modes, and these vibration modes are superimposed, thereby causing a driving vibration. In the case of the motor illustrated in FIG. 10A, two flexural vibration modes are excited in the vibrator 501 illustrated in FIGS. 10B-1 and 10B-2. Each of the two flexural vibration modes is a flexural vibration mode in an out-of-plane direction of the vibrator 501, which has a plate-like shape. One of the vibration modes is a second-order flexural vibration mode (Mode-A) in the longitudinal direction of the vibrator 501, and the other of the vibration modes is a first-order flexural vibration mode (Mode-B) in the width direction of the vibrator 501. The shape of the vibrator 501 is designed so that the resonant frequencies of the two vibration modes are the same or close to each other. The protrusions 503 and 504 are each disposed in the vicinity of a node of the vibration in Mode-A. Due to the vibration in Mode-A, end surfaces 503-1 and 504-1 of the protrusions each perform a pendulum motion around a pivot, which is a node of the vibration, and thereby perform a reciprocating motion in the X direction. The protrusions 503 and 504 are each disposed in the vicinity of an antinode of the vibration in Mode-B. Due to the vibration in Mode-B, end surfaces 503-1 and 504-1 of the protrusions each perform a reciprocating motion in the Z direction.

The vibrations in the two vibration modes (Mode-A and Mode-B) are excited so that the phase difference between the two vibration modes is about ±π/2, and superimposed, whereby the end surfaces 503-1 and 504-1 of the protrusions each perform an elliptical motion in the XZ plane. Due to the elliptical motions, the slider 506, which is in pressed contact with the protrusions 503 and 504, can be driven in one direction. At this time, the protrusions 503 and 504 of the vibrator 501 and the slider 506 intermittently contact each other with the drive frequency of the vibrator 501 (which is several tens of kHz or higher). Therefore, appropriate contact is not achieved unless either the protrusions 503 and 504 have appropriate spring characteristics or the slider has an appropriate spring characteristic. The protrusions 503 and 504 also function to amplify the vibration in the X direction as described above.

In order to fulfill these two functions, International Publication No. WO2008/056528A1 describes a vibration actuator including a vibrating body illustrated in FIGS. 11A to 11C. The vibrating body includes protrusions 609 and 610 that have spring characteristics and appropriate shapes, so that low-noise driving is realized. In the vibration actuator, the protrusions 609 and 610, which have spring characteristics, are machined as independent members, and the protrusions 609 and 610 are bonded to a base portion 602 so as to form the vibrating body.

With the vibration actuator described in International Publication No. WO2008/056528A1, a vibration can be amplified while maintaining a contact state as described above. On the other hand, this vibration actuator may have the following issues. In a vibrator 601 described in International Publication No. WO2008/056528A1, the protrusions 609 and 610 and the base portion 602 are independently machined as described above, and then integrated with each other by bonding or the like. When integrating, the protrusions 609 and 610 and the base portion 602 are to be uniformly bonded to each other without causing relative displacement. However, in reality, it is difficult to fulfill such a condition and manufacture the vibrating body stably due to a limitation on machining. Moreover, forming the protrusions as independent members and bonding them use man-hours, so that the cost of manufacturing is increased.

In order to solve such issues, Japanese Registered Utility Model No. 02542528 describes a technology for integrally forming the base portion and the protrusions. For example, in FIG. 11, the protrusions 609 and 610 and the base portion 602 are integrally formed from one member. However, this technology may have the following issues. First, the shapes of the protrusions 609 and 610 are not appropriate for integral formation. As described above, in order to fulfill the functions, the protrusions 609 and 610 each have a downwardly convex portion, and recesses 612 are formed in the base portion 602 so that the downwardly convex portions do not contact the base portion 602. Recesses in the piezoelectric element are formed in order to make a vibrator by bonding the piezoelectric element to a vibrating body that is formed by integrally forming the protrusions 609 and 610 having such shapes. However, the cost is increased in order to form the recesses in the piezoelectric element in post-processing. Moreover, fine cracks may be generated due to the post-processing and the strength may be decreased. On the other hand, if the recesses are formed when forming the piezoelectric element, the size of the recesses may deviate due to the deviation of contraction during sintering, so that the spring characteristics of the protrusions, which have fixed ends at the ends of the recesses, may deviate. Second, there may be an issue related to machining. In general, the protrusions are made of a difficult-to-process material having a high hardness (low extension), such as a stainless steel, because the shapes of the protrusions are complex, sliding characteristics (wear resistance) are required for the protrusions. Therefore, it is difficult to form protrusions having complex shapes as described above by using a machining method such as drawing, with which parts of a plate to become the protrusions are drawn and the thicknesses of such parts are reduced. Accordingly, with existing technologies, it is difficult to integrally form the protrusions and the base portion from one member.

The present invention provides a vibration wave driving apparatus and a method of making a vibrating body thereof, with which the vibrating body including protrusions can be made from one member at low cost and with a high reliability.

### SUMMARY OF THE INVENTION

According to an aspect of the present invention, an apparatus includes a vibrator, the vibrator including a vibrating body on which a protrusion having a spring characteristic is formed and an electromechanical energy conversion element, wherein the vibrator performs an elliptical motion so as to drive an object that is in contact with the protrusion, and wherein the protrusion is integrally formed with the vibrating body from one member in a partial area of the vibrating body with respect to a longitudinal direction and a width direction via a plurality of slits or cutouts.

According to another aspect of the present invention, a method of making a vibrating body of an apparatus, the vibration wave driving apparatus including a vibrator, the vibrator including the vibrating body on which a protrusion having a spring characteristic is formed and an electromechanical energy conversion element, the vibrator performing an elliptical motion so as to drive an object that is in contact with the protrusion, the method including preparing one member for integrally forming the protrusion and the vibrating body therefrom; forming a plurality of slits or cutouts for forming the protrusion in a partial area of the member; and forming the protrusion by bending a part of the member, the part being positioned between the slits or the cutouts.

Further features of the present invention will become apparent from the following description of exemplary embodiments with reference to the attached drawings.

### BRIEF DESCRIPTION OF THE DRAWINGS

FIG. 1 is a perspective view of a linear ultrasonic motor according to a first embodiment of the present invention.

FIGS. 2A and 2B illustrate a vibrating body according to the first embodiment of the present invention, in which FIG. 2A is a perspective view of the vibrating body and FIG. 2B is a sectional view of a protrusion.

FIGS. 3A and 3B illustrate the function of the protrusion according to the first embodiment of the present invention.

FIG. 4 is a perspective view of an example of the vibrating body according to the first embodiment of the present invention, which has a large slit width.

FIG. 5A is a perspective view of a vibrating body according to a second embodiment of the present invention, and FIG. 5B is a perspective view of a vibrating body according to a third embodiment.

FIGS. 6A, 6C, and 6D are sectional views and FIG. 6D is a perspective view illustrating protrusions of vibrating bodies according to a fourth embodiment of the present invention.

FIG. 7A is a perspective view of a vibrator according to a fifth embodiment of the present invention, FIG. 7B-1 is a perspective view of a vibrator according to a sixth embodiment, and FIG. 7B-2 is a sectional view of the vicinity of a protrusion of the vibrator.

FIG. 8 is a perspective view of a vibrating body according to a seventh embodiment of the present invention.

FIG. 9A is a perspective view of a vibrating body according to an eighth embodiment of the present invention before protrusions are formed, and FIG. 9B is a perspective view of the vibrating body according to the eighth embodiment of the present invention after the protrusions are formed.

FIGS. 10A, 10B-1, and 10B-2 illustrate an existing linear ultrasonic motor described in U.S. Pat. No. 7,109,639, in which FIG. 10A is an external perspective view of the linear ultrasonic motor and FIGS. 10B-1 and 10B-2 illustrate vibration modes excited in the vibrator.

FIG. 11A is a perspective view of a vibrator of a linear ultrasonic motor described in International Publication No. WO2008/056528A1, FIG. 11B is an enlarged view of a protrusion of the linear ultrasonic motor, and FIG. 11C is a sectional view of the protrusion.

FIG. 12 is a sectional view of a vibrator according to a ninth embodiment of the present invention.

FIG. 13A is a perspective view illustrating a first-order resonant longitudinal vibration excited in the vibrator according to the ninth embodiment of the present invention, and FIG. 13B is a perspective view illustrating a second-order resonant flexural vibration excited in the vibrator according to the ninth embodiment of the present invention.

FIG. 14 is a perspective view of the vibrating body according to the ninth embodiment of the present invention.

### DESCRIPTION OF THE EMBODIMENTS

Hereinafter, embodiments of the present invention will be described.

### First Embodiment

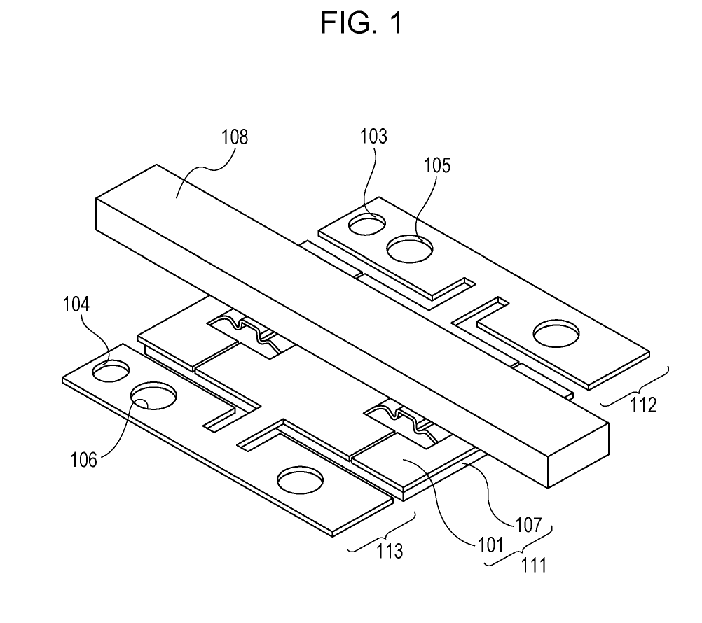

Referring to FIGS. 1 to 3B, a linear ultrasonic motor, which is an example of a vibration wave driving apparatus according to a first embodiment of the present invention and a method of making a vibrating body thereof will be described. As illustrated in these figures, the motor according to the present embodiment includes a vibrator 111, a slider 108, supporting members 112 and 113 that support the vibrator 111, and a pressing member (not shown) that makes the vibrator 111 and the slider 108 be in pressed contact with each other. The vibrator 111 includes a vibrating body 101 and a piezoelectric element 107, which are bonded to each other. The supporting members 112 and 113 are integrally formed with the vibrating body 101 from the same member.

In order to minimize the influence of the supporting members 112 and 113 on a vibration that is used for driving, the supporting members 112 and 113 are formed so as to extend from a position corresponding to a node of a second-order flexural vibration mode (the center of the vibrating body 101). Through-holes 103 and 104, which are used for positioning the vibrating body when forming the vibrating body, are formed in the supporting members 112 and 113. Through-holes 105 and 106, which are used for fastening the supporting members 112 and 113 to another component with screws, are formed in the supporting members 112 and 113. In the vibrating body 101, two protrusions 109 and 110, which are in contact with the slider 108, are integrally formed from the same member. The slider 108, which is magnetized, and the vibrating body 101 are in pressed contact with each other via the protrusions 109 and 110 due to magnetic attraction.

When an alternating electric field is applied from a power supply (not shown) to the piezoelectric element 107, two flexural vibration modes are excited in the vibrator 111, and an elliptical motion is produced at the contact surface of each of the protrusions 109 and 110. As a result, a frictional driving force is applied to the slider 108, which is in pressed contact with the protrusions 109 and 110, and the slider 108 is driven in the longitudinal direction of the slider 108.

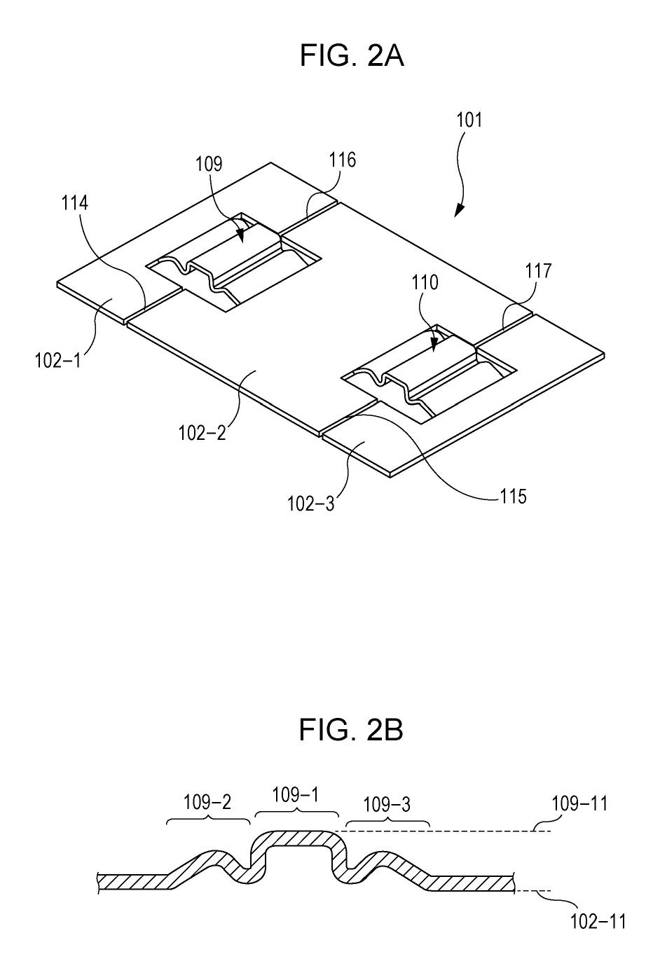

Referring to FIGS. 2A and 2B, the configuration of the vibrating body, which is an important aspect of the present embodiment, will be described. The vibrating body 101 includes a base portion 102 (including subportions 102-1, 102-2, and 102-3, the same shall apply hereinafter), and the protrusions 109 and 110. The protrusions 109 and 110 are integrally formed with the base portion 102 in a partial area of the vibrating body 101 with respect to the longitudinal direction and the width direction of the vibrating body 101 via a plurality of slits 114 and 115 that are formed adjacent to the protrusions 109 and 110. The protrusions 109 and 110 each include conversion portions 109-2 and 109-3 and a contact portion 109-1. The contact portion 109-1 has a contact surface that is to be in pressed contact with the slider 108. When the contact portion 109-1 is in contact with the slider 108, the contact portion acts substantially as a rigid body. The conversion portions 109-2 and 109-3, which are portions of each of the protrusions 109 and 110 excluding the contact portion 109-1, connect the contact portion 109-1 to the base portion 102, and become warped and deformed when the contact portion 109-1 contacts the slider 108. The conversion portions 109-2 and 109-3 each include a downwardly convex portion that is continuous with the contact portion 109-1 and an upwardly convex portion that is continuous with the downwardly convex portion. The conversion portions 109-2 and 109-3 are formed between a bonding surface 102-11 of the vibrating body 101 (a surface of the vibrating body 101 opposite to the surface on which the protrusions 109 and 110 are formed) and a contact surface 109-11 of the contact portion 109-1 (a surface of the contact portion 109-1 that contacts the slider 108). With such a structure, even when the protrusion 109 deforms, the conversion portions 109-2 and 109-3 do not contact a surface of the slider 108 or a surface of the piezoelectric element bonded to the base portion 102, and the conversion portions 109-2 and 109-3 have spring characteristics.

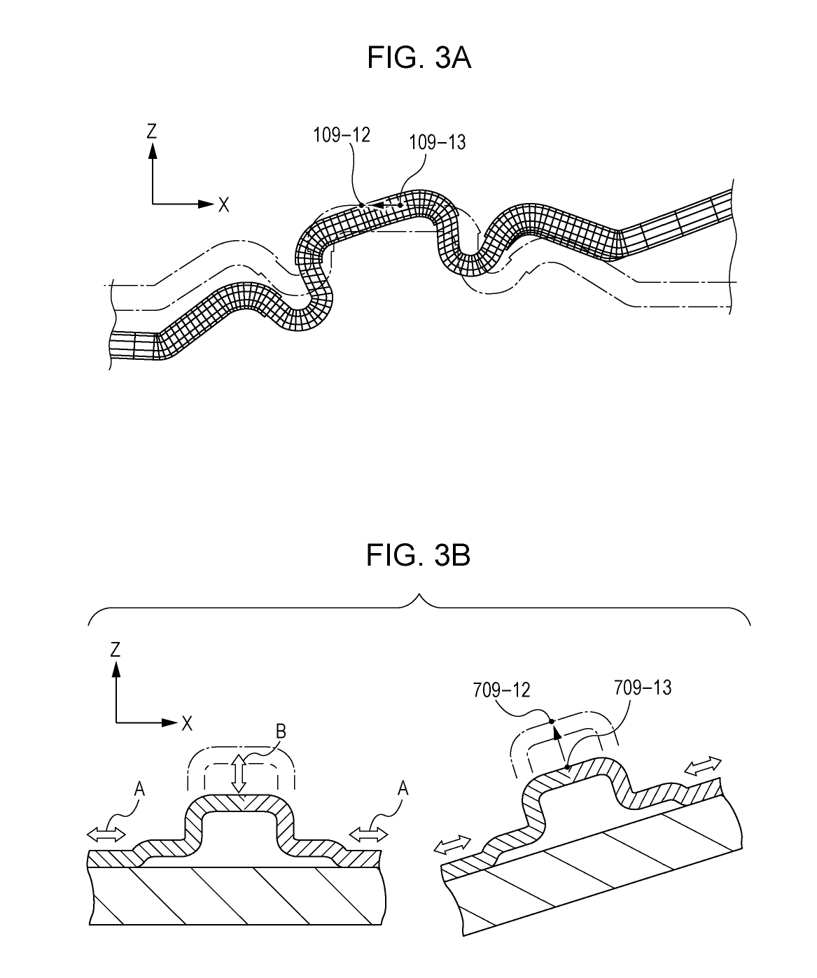

The conversion portions 109-2 and 109-3 deform together with the contact portion 109-1 when the base portion 102 deforms due to flexural vibration. The conversion portions 109-2 and 109-3 are designed to have appropriate shapes so that the contact portion 109-1 performs a desired vibration. For example, if the protrusion 109 has a shape illustrated in FIG. 3B, when the piezoelectric element extends and contracts in the direction of arrow A due to a vibration, the conversion portions 109-2 and 109-3 of the protrusion 109 extend and contract in the direction of arrow A. As a result, the contact portion vibrates in the direction of arrow B. In an actual second-order flexural vibration, the center of the surface of the contact portion is displaced in the Z direction from a point 709-13 to a point 709-12. Therefore, if a driving vibration is generated by combining this vibration with another driving vibration mode (a mode in which the protrusion 109 is vibrated in the Z direction, which is not shown), the contact portion 109-1 performs a tilted elliptical vibration, so that a driving force is not efficiently transferred. On the other hand, if the protrusion 109 has the shape illustrated in FIG. 2B, a second-order flexural vibration is generated in the longitudinal direction of the vibrator 111. Therefore, even when the piezoelectric element deforms, the displacement of the center of the surface of the contact portion in the Z direction due to the deforming is minimized as illustrated in FIG. 3A. As illustrated in FIG. 3A, in the vibrator having the shape according to the present embodiment, the direction of displacement (vibration angle) from the center of the surface of the contact portion 109-13 before being deformed to the center of the surface of the contact portion 109-12 after being deformed can be made equal to or smaller than 6° when the X direction is assumed to be 0° and the Z direction is assumed to be 90°. Thus, when being combined with another vibration mode in the Z direction, an elliptical vibration having a small tilt angle can be generated.

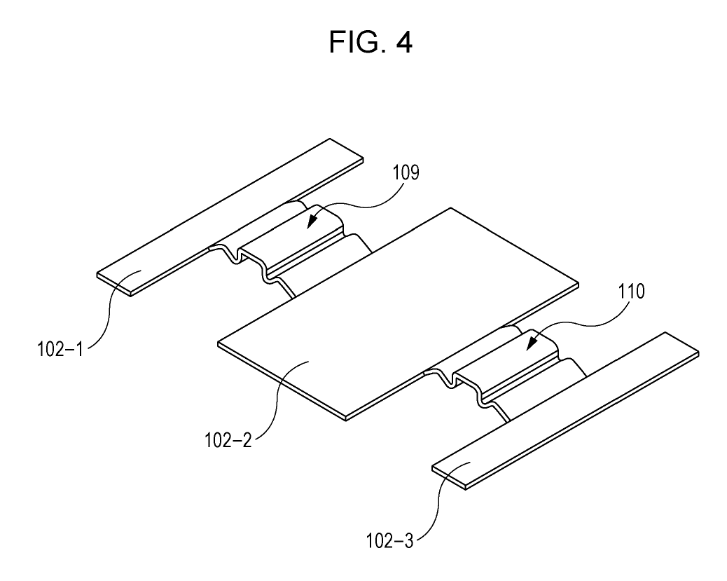

In the present embodiment, the vibrating body 101 is made of a stainless steel material, such as SUS420J2 or SUS440C, which are wear-resistant. In the present embodiment, in order to provide a sufficient bonding strength when bonding or joining the vibrating body 101 to another member, such as the electromechanical energy conversion element, the size of the joint (bonding) area is increased by minimizing the size the slit portion or a cutout portion in the vibrating body 101. If the vibrator is sufficiently large and a large bonding area is provided without reducing the size of the slit, the vibrating body 101 may have a shape illustrated in FIG. 4. The vibrating body according to the present embodiment may be made by using a method including the following steps. First, a member that serves as a base portion, in which the protrusion and the vibrating body are integrally formed with each other, is prepared, and slits or cutouts are formed in a partial area of the member. Next, a part of the base portion surrounded by the slits or the cutouts is bent so as to form the protrusions. By thus bending a part of the base portion, the protrusions including the contact portions and the conversion portions are formed.

### Second Embodiment

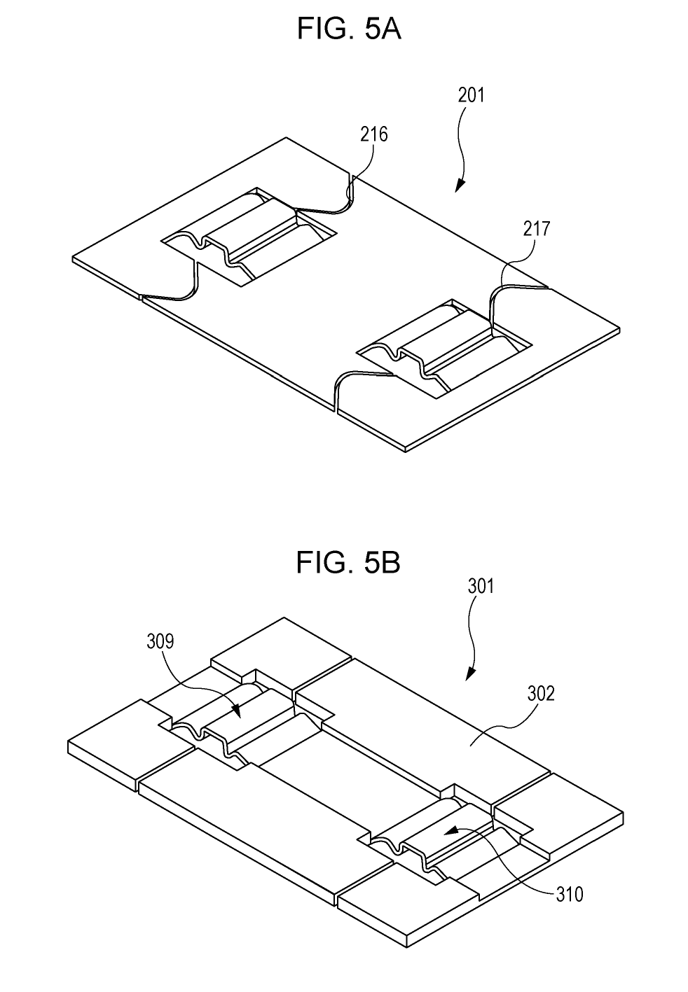

Referring to FIG. 5A, a second embodiment of the present invention will be described. In the present embodiment, the slits in a vibrating body 201 are curved. If the slits extend in the lateral direction as illustrated in FIG. 1, the slits are parallel to an antinode portion or a node portion of a flexural mode, whereby the flexural rigidity may be reduced. In order to reduce such an influence, the slits are curved as illustrated in FIG. 5A.

### Third Embodiment

Referring to FIG. 5B, a third embodiment of the present invention will be described. In the present embodiment, the thickness of a base portion 302 of a vibrating body 301 (the thickness of a base portion) is uneven. Here, a pre-deformed member provided with an uneven thickness by extrusion, drawing, pressing, or the like is used. In this case, protrusions may be formed in a part of the base portion 302 having a small thickness (thickness of the base portion). For example, by increasing the volume of the vibrating body 301 while maintaining the spring stiffness of the protrusion 309 at a desired value and by reducing the distance between the base portion 302 and the slider (not shown), the magnetic attraction between the vibrating body 301 and the slider, which is magnetized, can be increased. Moreover, the distribution of the tensile stress in the thickness direction in the flexural mode can be adjusted, so that the output power of the piezoelectric element is efficiently utilized. In the present embodiment, a pre-deformed member having an uneven thickness is used. Alternatively, the thickness of a desired portion may be adjusted by etching or the like.

### Fourth Embodiment

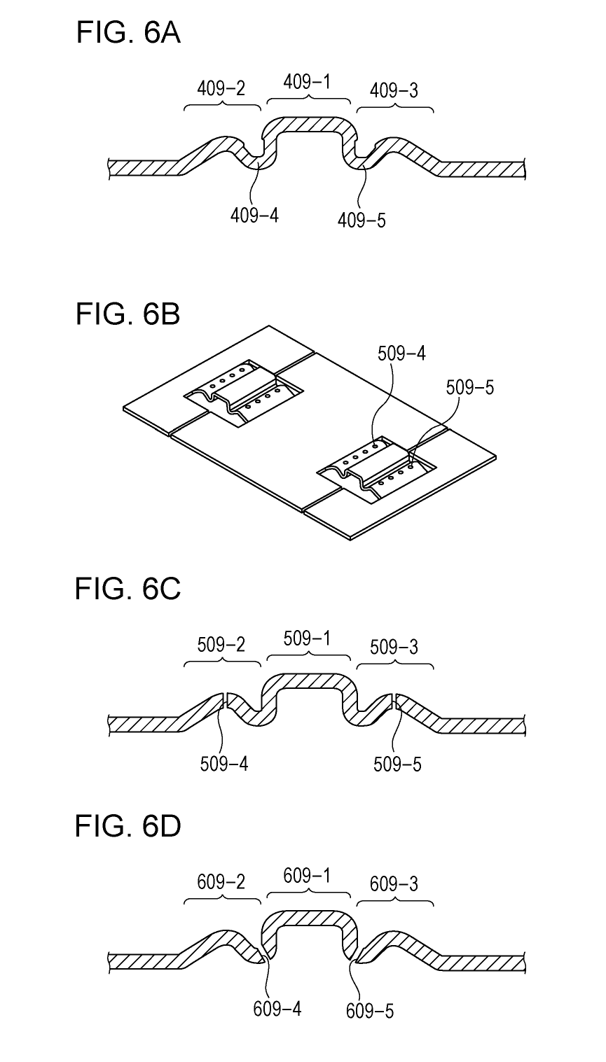

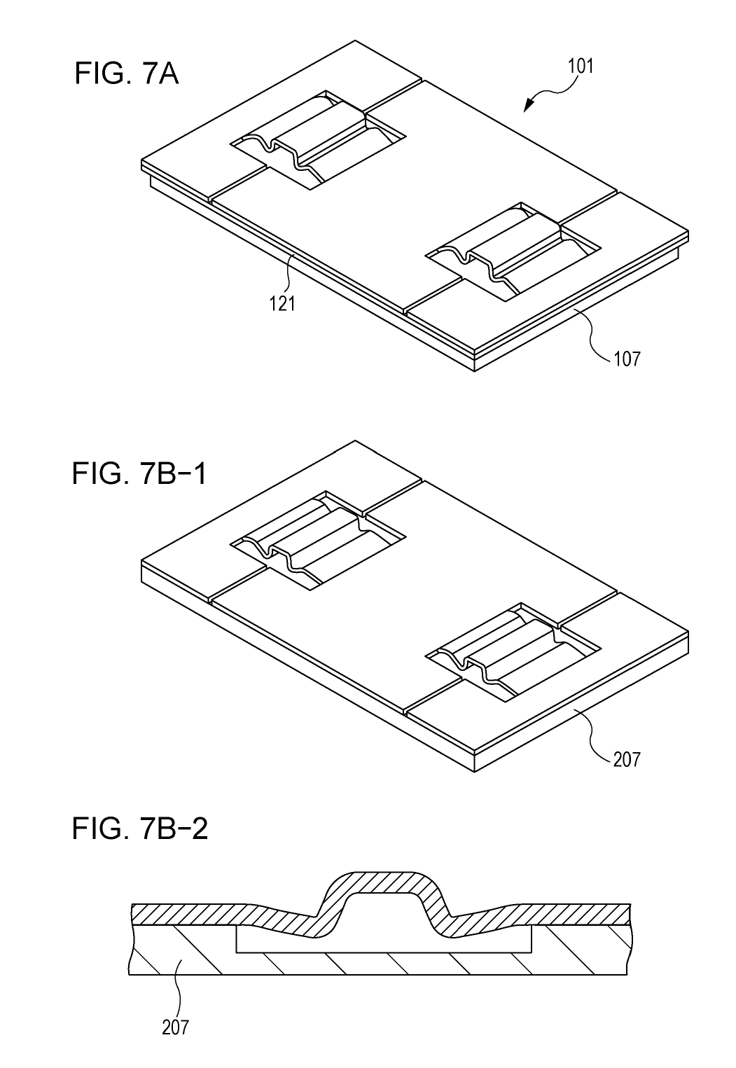

Referring to FIG. 6A, a fourth embodiment of the present invention will be described. In the present embodiment, the thickness of parts of the conversion portions 409-2 and 409-3, in particular, the thickness of downwardly convex portions 409-4 and 409-5 is small. With such a configuration, the flexural rigidity of the parts of the conversion portions can be adjusted to be lower than the flexural rigidity of the base portion of the vibrating body, or the vibration angle of the contact surface of the protrusion in a vibration mode can be adjusted. Note that, the same effect can be produced when a plurality of holes, such as holes 509-4 and 509-5, are formed in parts of the conversion portions 509-2 and 509-3 as illustrated in FIG. 6B. The diameter, the number, and the disposition of the holes may be adjusted with consideration of the vibration angle or the spring stiffness. FIG. 6C is a sectional view taken along a plane that passes through the hole 509-4 of FIG. 6B. In this case, the holes 509-4 and 509-5 are formed in upwardly convex portions of the conversion portions 509-2 and 509-3. In FIG. 6D, the holes 609-4 and 609-5 are formed in downwardly convex portions of the conversion portions 609-2 and 609-3.

### Fifth Embodiment

Referring to FIG. 7A, a fifth embodiment of the present invention will be described. In the present embodiment, a vibrator includes a plate member 121 that is disposed between the vibrating body 101 and the piezoelectric element 107, which is an electromechanical energy conversion element. With such a structure, the magnetic attraction between the vibrating body 101 and the slider is increased, and the distribution of (tensile) stress due to the flexural vibration described above can be adjusted. The material of the plate is not particularly limited. However, in order to reduce the vibration loss of the vibrator, a metal material such as a steel alloy or a copper alloy may be used.

### Sixth Embodiment

Referring to FIGS. 7B-1 and 7B-2, a sixth embodiment of the present invention will be described. In the present embodiment, as with the shape of the protrusion described in International Publication No. WO2008/056528A1, the conversion portions of the protrusion extend to a level below the bonding surface between the vibration plate and the piezoelectric element. Therefore, in the present embodiment, recesses are formed in the piezoelectric element so that the piezoelectric element does not contact the conversion portions. If the plate member 121 is disposed between the vibrating body and the piezoelectric element as in the fifth embodiment, the recesses may be formed in the plate member 121.

### Seventh Embodiment

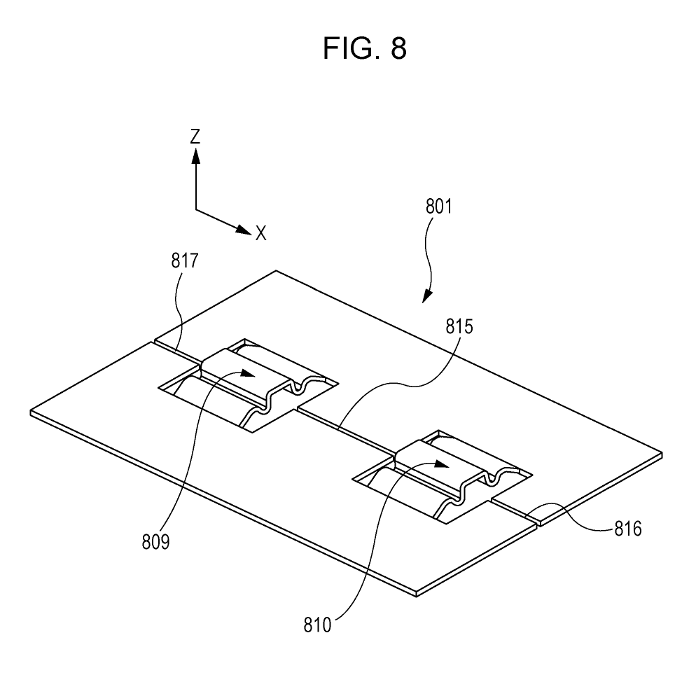

Referring to FIG. 8, a seventh embodiment of the present invention will be described. In the present embodiment, slits 815, 816, and 817 extend in the longitudinal direction of a vibration plate 801. Ends of the slits 816 and 817 flush with end surfaces of the vibration plate 801 in the width direction. Thus, the rigidity of the protrusions in a direction in which the slider is driven (the X direction) can be independently set so as to be higher than the rigidity of the protrusions in a direction perpendicular to the direction in which the slider is driven (the Z direction).

### Eighth Embodiment

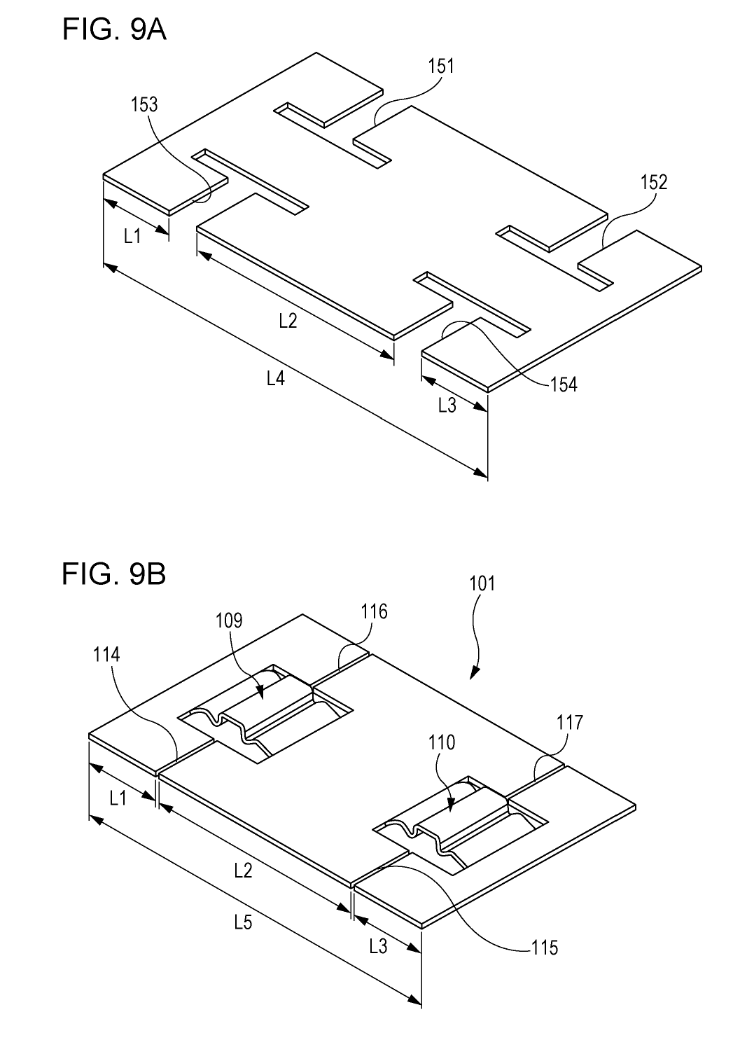

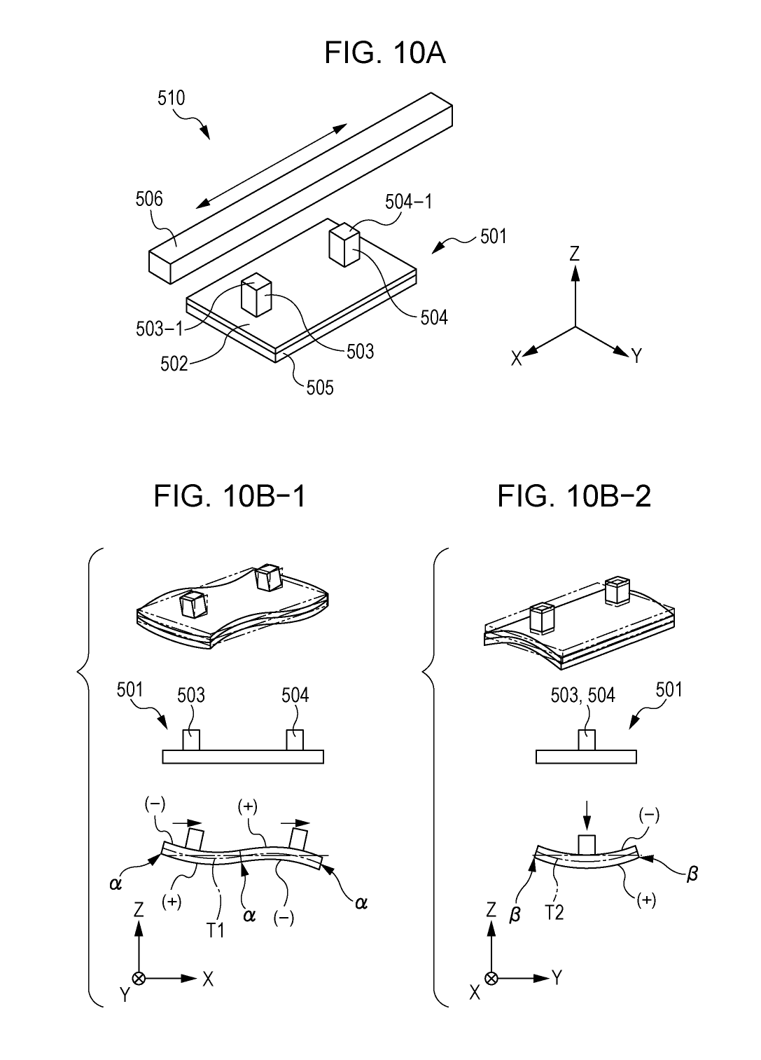

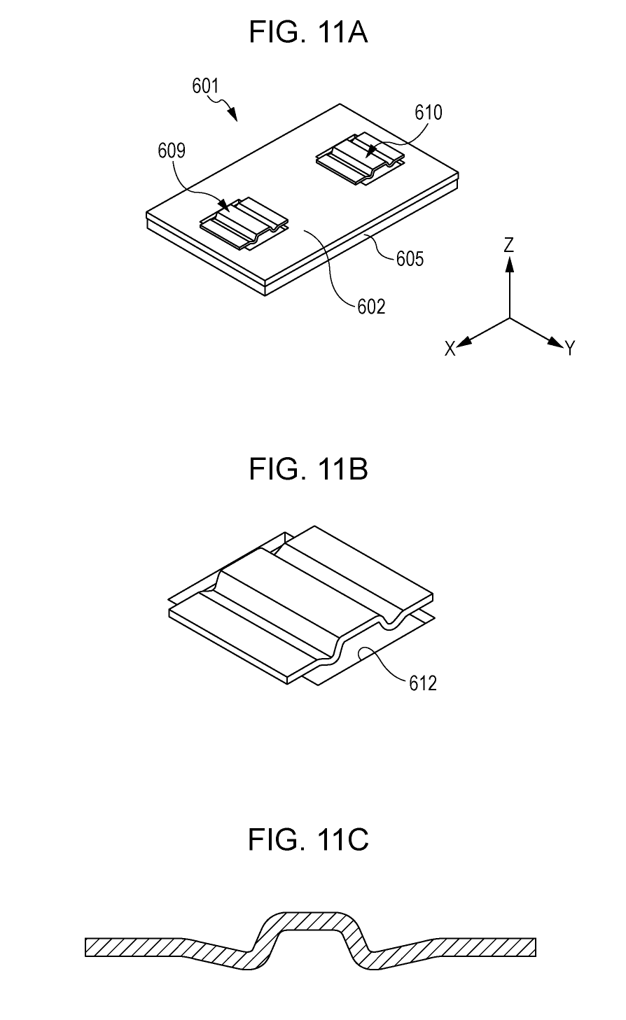

Referring to FIGS. 9A and 9B, an eighth embodiment of the present invention will be described. In the present embodiment, the vibrating body is made of a stainless steel material, such as SUS420J2 or SUS440C, which is wear-resistant. A plate having a length L4, which is larger than the length L5 of the vibrating body 101 (in the longitudinal direction), is prepared. As illustrated in FIG. 9A, cutout portions 151 to 154 are formed on both sides of the areas in which the protrusions 109 and 110 are to be formed. The cutout portions 151 to 154 are formed by etching or by press-punching, and then the protrusions 109 and 110 are formed by bending. FIG. 9B illustrates the shape of the vibrating body after such machining is finished. Parts of the cutout portions 151 to 154 become slits 114 to 117, each having a small width. By thus forming the protrusions by bending, the thicknesses of the protrusions 109 and 110 before and after being machined do not substantially change. As a result, the shape of protrusions is less limited than in the case where a machining method such as drawing or forging, which has a high stretching ability for a plate, is used.

### Ninth Embodiment

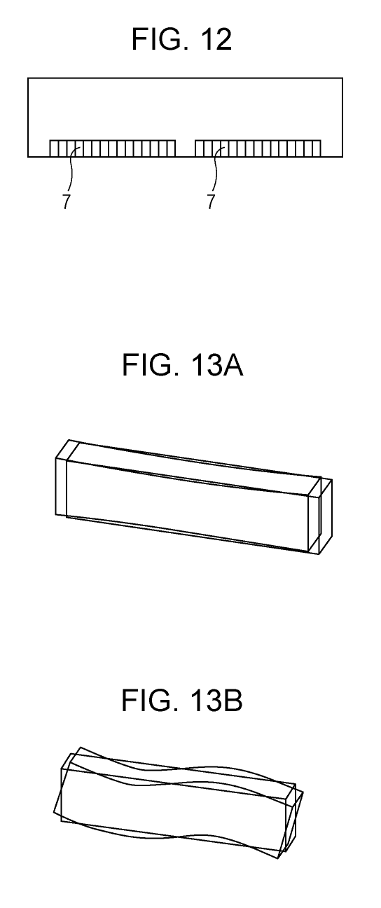

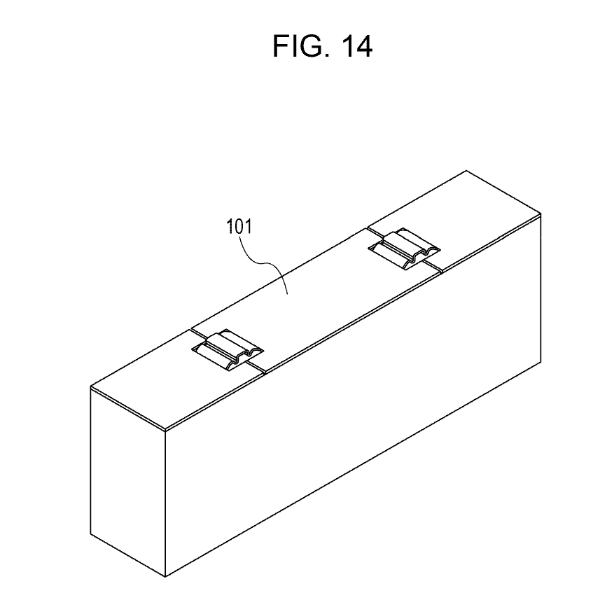

Referring to FIGS. 12 to 13B, a ninth embodiment of the present invention will be described. The ninth embodiment differs from other embodiments in that the vibrator is made to perform vertical vibration (extension-contraction vibration) and bending vibration (flexural vibration) and an elliptical motion is generated by combining these vibrations. A method of generating such a mode will be described. Piezoelectric elements 7 are disposed on a vibrating body as illustrated in FIG. 12. When the phase of the left piezoelectric element (phase A) and the phase of the right piezoelectric element (phase B) are the same and an alternating voltages are applied to the piezoelectric elements, a first-order resonant vibration illustrated in FIG. 13A is excited. On the other hand, when the phase A and the phase B are opposite to each other, a second-order resonant flexural vibration illustrated in FIG. 13B is excited. When the phase A and the phase B are shifted from each other by 90 degrees, elliptical vibrations are excited at several positions on a surface of the vibrating body. By forming protrusions at the positions at which the elliptical motions are generated, a slider that is in pressed contact with the protrusions can be driven in one direction. For the vibration mode described above, by providing the vibrating body with the shape described in the first to eighth embodiments, for example, the vibrating body 101, which includes the protrusions as illustrated in FIG. 14, can be integrally formed from one member. An elastic body may be disposed between the vibrating body, which is integrated with the protrusions, and the piezoelectric element. With such a structure, the vibrating body can be displaced by a large distance due to the elastic body even if the displacement distance is reduced to a certain extent due to the presence of the slit portions in the vibrating body. By making the elastic body from a material having a thermal expansion coefficient that is larger than those of the piezoelectric element and the vibrating body, a stress-strain between the piezoelectric element and the vibrating body can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-058779 filed Mar. 16, 2010 and No. 2011-007695 filed Jan. 18, 2011, which are hereby incorporated by reference herein in their entirety.

What is claimed is:

1. An apparatus comprising:
a vibrator including
a vibrating body on which a protrusion having a spring characteristic is formed, and
an electromechanical energy conversion element,
wherein the vibrator performs an elliptical motion so as to drive an object that is in contact with the protrusion, and
wherein the protrusion is integrally formed with the vibrating body from one member in a partial area of the vibrating body with respect to a longitudinal direction and a width direction via a plurality of slits or cutouts.

2. The apparatus according to claim 1,
wherein the protrusion is formed adjacent to the slits or the cutouts.

3. The apparatus according to claim 2,
wherein the protrusion includes a contact portion and a conversion portion, the contact portion having a contact surface that contacts the object, and
wherein the conversion portion is disposed between a surface of the vibrating body, the surface being opposite to a surface of the vibrating body on which the protrusion is formed, and the contact surface of the contact portion that contacts the object.

4. The apparatus according to claim 3,
wherein the conversion portion includes a downwardly convex portion that is continuous with the contact portion and an upwardly convex portion that is continuous with the downwardly convex portion.

5. The apparatus according to claim 4,
wherein a flexural rigidity of a part of the conversion portion is lower than a flexural rigidity of a base portion of the member from which the vibrating body is formed.

6. The apparatus according to claim 5,
wherein a part of the conversion portion has a small thickness or a small width, or a hole is formed in a part of the conversion portion.

7. The apparatus according to claim 1,
wherein a thickness of a base portion of the member from which the vibrating body is formed is uneven.

8. The apparatus according to claim 7,
wherein the protrusion is formed in a part of the base portion having a small thickness.

9. The apparatus according to claim 2,
wherein a thickness of a base portion of the member from which the vibrating body is formed is uneven.

10. The apparatus according to claim 3,
wherein a thickness of a base portion of the member from which the vibrating body is formed is uneven.

11. The apparatus according to claim 4,
wherein a thickness of a base portion of the member from which the vibrating body is formed is uneven.

12. The apparatus according to claim 5,
wherein a thickness of a base portion of the member from which the vibrating body is formed is uneven.

13. The apparatus according to claim 6,
wherein a thickness of a base portion of the member from which the vibrating body is formed is uneven.

14. The apparatus according to claim 1,
wherein the vibrator includes a plate member disposed between the vibrating body and the electromechanical energy conversion element.

15. A method of making a vibrating body of an apparatus, the apparatus including a vibrator, the vibrator including the vibrating body on which a protrusion having a spring characteristic is formed and an electromechanical energy conversion element, the vibrator performing an elliptical motion so as to drive an object that is in contact with the protrusion, the method comprising:
preparing one member for integrally forming the protrusion and the vibrating body therefrom;
forming a plurality of slits or cutouts for forming the protrusion in a partial area of the member; and
forming the protrusion by bending a part of the member, the part being positioned between the slits or the cutouts.

16. The method according to claim 15,
wherein the protrusion is formed adjacent to the slits or the cutouts.

17. The method according to claim 16, further comprising:
disposing the conversion portion between a surface of the vibrating body, the surface being opposite to a surface of the vibrating body on which the protrusion is formed, and the contact surface of the contact portion that contacts the object,
wherein the protrusion includes a contact portion and a conversion portion, the contact portion having a contact surface that contacts the object.

18. The method according to claim 17,
wherein the conversion portion includes a downwardly convex portion that is continuous with the contact portion and an upwardly convex portion that is continuous with the downwardly convex portion.

19. The method according to claim 18,
wherein a flexural rigidity of a part of the conversion portion is lower than a flexural rigidity of a base portion of the member from which the vibrating body is formed.

20. The method according to claim 15,
wherein a thickness of a base portion of the member from which the vibrating body is formed is uneven.
